(19) United States
(12) Patent Application Publication
(10) Pub. No.: US 2014/0236940 A1
(43) Pub. Date: Aug. 21, 2014

(54) SYSTEM AND METHOD FOR ORGANIZING SEARCH RESULTS

(71) Applicant: STREMOR CORPORATION, Scottsdale, AZ (US)

(72) Inventors: Brandon Wirtz, Phoenix, AZ (US); William Irvine, Scottsdale, AZ (US)

(73) Assignee: Stremor Corporation, Scottsdale, AZ (US)

(21) Appl. No.: 13/772,000

(22) Filed: Feb. 20, 2013

(51) Int. Cl. G06F 17/30

(52) U.S. Cl. CPC G06F 17/3053
USPC 707/730

(57) ABSTRACT

Some embodiments concern a method for organizing two or more search results. The method includes: receiving at least one search parameter from a user; using at least one computer processor to determine a search type based upon the at least one search parameter; using the at least one computer processor to determine potential search results based upon the at least one search parameter; using the at least one computer processor to determine one or more qualitative traits of the potential search results; using the at least one computer processor to organize the two or more search results based upon the search type and the one or more qualitative traits of the potential search results; and displaying the two or more search results to the user. Other embodiments are disclosed.

### FIELD OF THE INVENTION

This invention relates generally to computer aided searching of information, and relates more particularly to computer systems and methods for searching of information using qualitative factors.

### DESCRIPTION OF THE BACKGROUND

People often search for documents on the Internet using search engines. Many search engines attempt to find the desired document from the multitude of information available on the web. Users often submit queries to the search system, and the search system returns relevant documents (i.e., search results) with respect to the queries.

Typical search results are ranked only by quantitative factors. That is, the search engines rank the search results based upon objective or easily quantifiable properties (e.g., number of times the search term appears in the document, and/or number of other web pages that link to the document). Ranking based solely on quantitative factors does not always produce optimal search results.

Accordingly, a need or potential for benefit exists for a method or system that uses both quantitative and qualitative factors to determine the best search results for a user query.

### BRIEF DESCRIPTION OF THE DRAWINGS

To facilitate further description of the embodiments, the following drawings are provided in which:

FIG. 1 illustrates a box diagram of a computer system configured to generate search results according to a first embodiment;

FIG. 2 illustrates a flow chart for a method of generating search results according to the first embodiment;

FIG. 3 illustrates an exemplary interface, according to the first embodiment;

FIG. 4 illustrates a flow chart for an example of an activity of determining a classification of the potential search results, according to the first embodiment;

FIG. 5 illustrates an example of a sample mark-up for a sentence, according to an embodiment;

FIG. 6 illustrates an example of a word frequency table of a sample source, according to an embodiment;

FIG. 7 illustrates a flow chart for an example of an activity of communicating the search results to the user, according to the first embodiment;

FIG. 8 illustrates an exemplary search results page, according to an embodiment;

FIG. 9 illustrates a computer that is suitable for implementing an embodiment of computer system of FIG. 1; and

FIG. 10 illustrates a representative block diagram of an example of the elements included in the circuit boards inside chassis of the computer of FIG. 9.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

### DETAILED DESCRIPTION OF EXAMPLES OF EMBODIMENTS

Some embodiments concern a method for organizing two or more search results. The method includes: receiving at least one search parameter from a user; using at least one computer processor to determine a search type based upon the at least one search parameter; using the at least one computer processor to determine potential search results based upon the at least one search parameter; using the at least one computer processor to determine one or more qualitative traits of the potential search results; using the at least one computer processor to organize the two or more search results based upon the search type and the one or more qualitative traits of the potential search results; and displaying the two or more search results to the user.

Various embodiments concern a system configured to generate search results from three or more sources based upon one or more trigger words received from a user. The system generates the search results using at least one computer processor. The system can include: a communications module configured to be executed using the at least one computer processor and further configured to receive the one or more trigger words from the user and to communicate the search results to the user; a preliminary results module configured to be executed using the at least one computer processor and further configured to determine potential search results based upon the one or more trigger words, the potential search results comprises at least two potential sources from the three or more sources; an analysis module to determine a search type based upon the one or more trigger words; a classification module configured to classify the potential search results into two or more predetermined qualitative categories based on a content of the at least two potential sources; a mix module configured to determine an editorial mix of the search results based upon the search type and the potential search results, the editorial mix comprises two or more types of sources; a scoring module configured to determine a score for each source in the potential search results at least partially based upon the editorial mix of the search results; and a results determining module configured to create the search results at least partially based upon the potential search results, the editorial mix of the search results, and the score for each source in the potential search results.

Many embodiments can concern a method for displaying information to a user based upon one or more trigger words. The method can include: receiving the one or more trigger words from the user; using at least one computer processor to determine a search type based upon the one or more trigger words; using the at least one computer processor to determine an editorial mix based upon the search type, the editorial mix comprises two or more types of sources; using the at least one computer processor to determine potential search results based upon the one or more trigger words, the potential search results comprise at least two potential sources; using the at least one computer processor to determine one or more classifications of the potential search results into two or more qualitative categories based on a content of the potential search results; using the at least one computer processor to determine scores for the at least two potential sources at least partially based upon the editorial mix; using the at least one computer processor to determine search results at least partially based upon the potential search results, the editorial mix, and the scores for the at least two potential sources; and communicating the search results to the user.

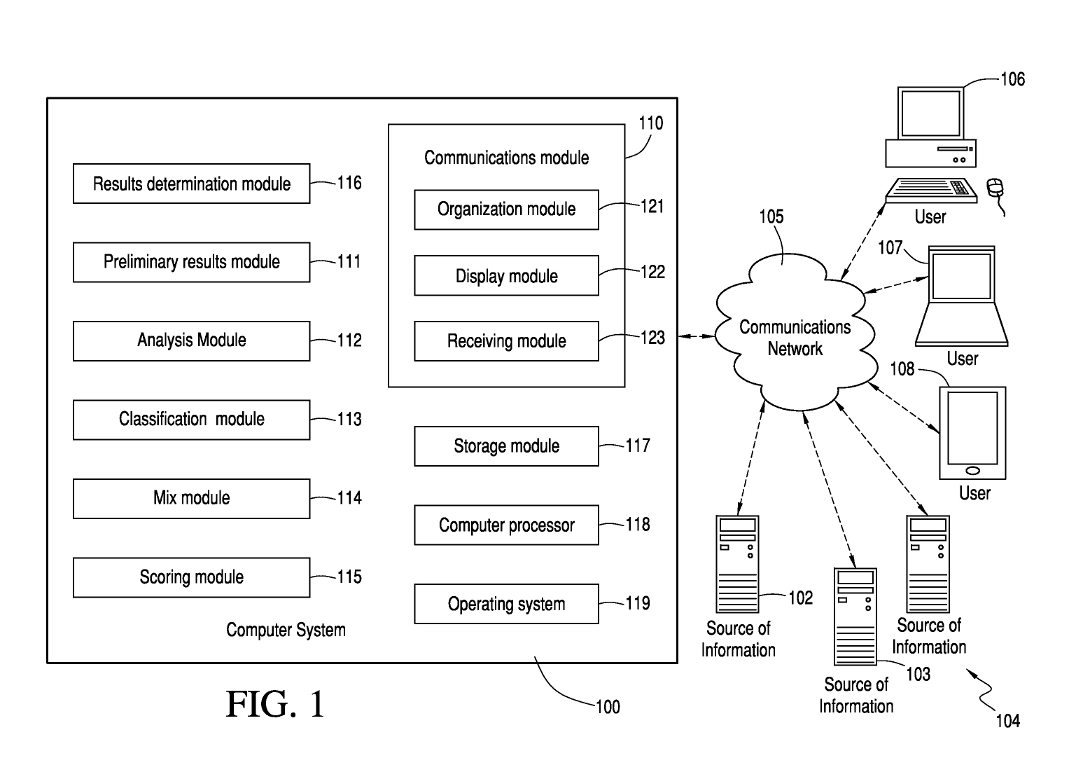

Turning to the drawings, FIG. 1 illustrates a box diagram of a computer system 100 configured to generate search results from three or more sources based upon one or more trigger words, according to a first embodiment. In some examples, computer system 100 can also be considered a computer system for editorializing results using qualitative traits of the content of the search results or a system for displaying information to a user based upon one or more trigger words. Computer system 100 also can be considered a system for efficient qualitative scoring of text or textually tagged content in various examples or a system for organizing search results. Computer system 100 is merely exemplary and is not limited to the embodiments presented herein. Computer system 100 can be employed in many different embodiments or examples not specifically depicted or described herein.

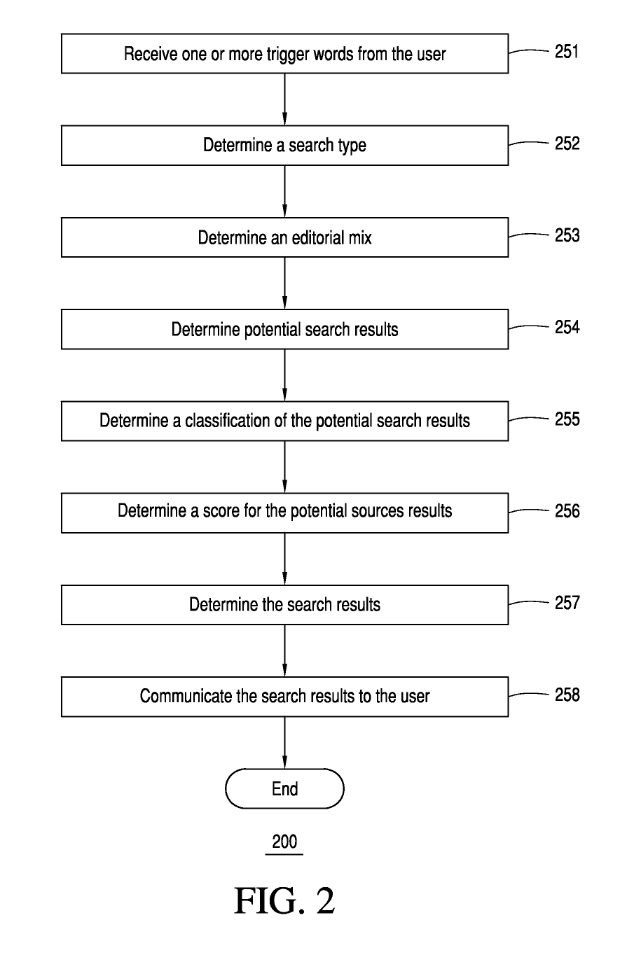

Not to be taken in a limiting sense, a simple example of the usage of computer system 100 and method 200 (FIG. 2) can involve a user searching for a review of a new car. In this example, the user is searching for a model of “Pygmy” manufactured by an imaginary manufacturer “Romerts.”

When the user searches for “Romerts Pygmy Review” in a search window on a website, computer system 100 identifies that this search is a “comparison search” and determines an editorial mix and search results based on that type of search. In this example, system 100 returns to the user search results that include the manufacture's site as the top result (especially if the manufacturer's website has a page that links to reviews), an “Encyclopedic” result (a reference that expresses primarily quantitative information about the topic), two journalistic reviews of the topic (similar to the type of content found in Consumer Reports that expresses opinion, but it is based on facts, and provided by an expert), and a rant liking and a rant disliking the Romerts Pygmy car.

Referring to FIG. 1, in some embodiments, computer system 100 can be configured to receive search parameters or terms (i.e., trigger words) from users 106, 107, and/or 108, and search the information (e.g., web pages, documents, databases) stored by sources 102, 103, and/or 104.

In some examples, computer system 100 (e.g., a search engine) can include: (a) a communications module 110 configured to receive trigger words from user 106, 107, and/or 108 and to communicate the search results to the user; (b) a preliminary results module 111 configured to determine potential search results based upon the trigger words; (c) an analysis module 112 to determine a search type based upon the trigger words; (d) a classification module 113 configured to classify the potential search results; (e) a mix module 114 configured to determine an editorial mix of the search results based upon the search type and the potential search results; (f) a scoring module 115 configured to determine a score for each source in the potential search results at least partially based upon the editorial mix of the search results; (g) a results determining module 116 configured to create the search results at least partially based upon the potential search results; (h) a storage module 117; (i) a computer processor 118; and (j) an operating system 119.

Communications module 110 can include: (a) an organization module 121; (b) display module 122; and (c) receiving module 123. Organization module 121 can be configured to organize the search results based upon the classification of the potential search results. Organization module 121 can be further configured to determine the information to display to the user (e.g., user 106) information from a first source (e.g., source 102), where the first source has a particular classification.

Display module 122 can be configured to visually display information from or about the search results to the user (e.g., user 106) on a web page or other display mechanism. Receiving module 123 can be configured to receive the search parameters (i.e., trigger words) from users 106, 107, and/or 108.

In various embodiments, classification module 113 can be configured to classify the potential search results into two or more predetermined qualitative categories based on the content of the information of at least one of sources 102, 103, or 104. In some examples, the two or more predetermined qualitative categories or classifications can include writing style, point-of-view of the author, timeframe (e.g., past, recent, present, future), the level of formality of the content, is the content written from instructive purposes (e.g., “How To” work or instructions), and is the content a critique or a review. For example, classification module 113 can be configured to determine a writing style and/or a point-of-view of each potential search result.

Classification module 113 can be further configured to determine the classification by: (a) creating a meta-document based upon the content of a first source (e.g., source 102); (b) determine a frequency and parts-of-speech (e.g., nouns, verbs, adjectives, adverbs, etc.) of each word in the meta-document; and (c) determine the classification of source 102 using the frequency and the parts-of-speech of each word in the meta-document.

Communications network 105 can be a combination of public and/or private computer networks. For example, communications network 108 can include one or more of the Internet, an Intranet, local wireless or wired computer networks (e.g. a 4G (fourth generation) cellular network), wide area network (WAN), local area network (LAN), cellular telephone networks, or the like. In many embodiments, computer system 100 communicates with users 106, 107, and 108 and sources 102, 103, and 104 using communications network 105.

“Computer System 100,” as used herein, can refer to a single computer, single server, or a cluster or collection of servers. Typically, a cluster or collection of servers can be used when the demands by client computers (e.g., users 106, 107, and 108) are beyond the reasonable capability of a single server or computer. In many embodiments, the servers in the cluster or collection of servers are interchangeable from the perspective of the client computers.

In some examples, a single server can include communications module 110, preliminary results module 111, analysis module 112, classification module 113, mix module 114, scoring module 115, and results determining module 116. In other examples, a first server can include a first portion of these modules. One or more second servers can include a second, possibly overlapping, portion of these modules. In these examples, computer system 100 can comprise the combination of the first server and the one or more second servers.

In some examples, storage module 117 can include information or indexes used by computer system 100. The information can be stored on a structured collection of records or data, for instance, which is stored in storage module 117. For example, the indexes stored in storage module 117 can be an XML (Extensible Markup Language) database, MySQL, or an Oracle® database. In the same or different embodiments, the indexes could consist of a searchable group of individual data files stored in storage module 117.

In various embodiments, operating system 119 can be a software program that manages the hardware and software resources of a computer and/or a computer network. Operating system 119 performs basic tasks such as, for example, controlling and allocating memory, prioritizing the processing of instructions, controlling input and output devices, facilitating networking, and managing files. Examples of common operating systems for a computer include Microsoft® Windows, Mac® operating system (OS), UNIX® OS, and Linux® OS.

As used herein, “computer processor” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions.

FIG. 2 illustrates a flow chart of a method 200 of generating search results from three or more sources (e.g., source 102, 103, and 104 (FIG. 1)) based upon one or more trigger words, according to the first embodiment. In some examples, method 200 can also be considered a method to editorialize results using qualitative traits of the content of search results or a method for displaying information to a user based upon one or more trigger words. Method 200 also can be considered a method for qualitatively scoring text or textually tagged content or a method of organizing search results.

Method 200 is merely exemplary and is not limited to the embodiments presented herein. Method 200 can be employed in many different embodiments or examples not specifically depicted or described herein. In some embodiments, the activities, the procedures, and/or the processes of method 200 can be performed in the order presented. In other embodiments, the activities, the procedures, and/or the processes of method 200 can be performed in any other suitable order. In still other embodiments, one or more of the activities, the procedures, and/or the processes in method 200 can be combined or skipped.

Referring to FIG. 2, method 200 includes an activity 251 of receiving one or more trigger words (e.g., “Romerts Pygmy Review”) from the user. Referring back to FIG. 1, in some examples, one of users 106, 107, or 108 can use a computing device to enter and/or transmit the trigger words to computer system 100. In many examples, the trigger words are transmitted to computer system 100 from user 106, 107, or 108 over communications network 105 (i.e., the Internet or another computer network).

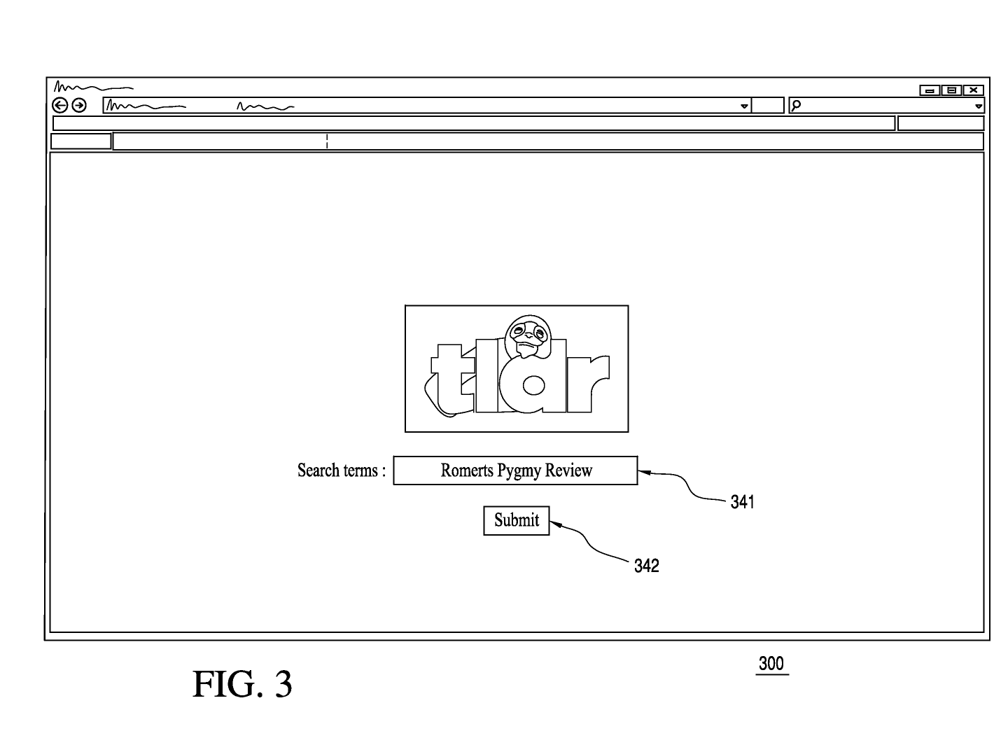

In various embodiments, computer system 100 can generate and/or display one or more web pages and/or other interfaces that user 106, 107, or 108 can use to submit or send the one or more to computer system 100. For example, FIG. 3 illustrates an exemplary interface 300 where the trigger words can be entered by a user, according to the first embodiment. In the example of FIG. 3, one of users 106, 107, or 108 (FIG. 1) can enter the trigger word(s) (e.g., “Romerts Pygmy Review”) into a text box 341 on interface 300 (e.g., a web page). When the user clicks the submit button 342, the user's computing device can transmit the trigger words to receiving module 123 (FIG. 1) via communications network 105 (FIG. 1).

Referring back to FIG. 2, method 200 in FIG. 2 continues with an activity 252 of determining a search type. In some examples, activity 252 can include using at least one computer processor to determining a search type. In various examples, analysis module 112 (FIG. 1) can determine the search type. The search type is used to determine the mix of information to display to the user as part of the search results. Depending on the type of search, computer system 100 (FIG. 1) can display different mixes and orders of search results.

In some examples, activity 252 can include using at least one computer processor to determine a search type based upon the trigger words. In many embodiments, analysis module 112 (FIG. 1) can determine the search type based upon the one or more trigger words. In many embodiments, analysis module 112 (FIG. 1) can identify the search type based on the meaning of the one or more trigger words. For example, if the trigger words were “Romerts Pygmy review,” analysis module 112 (FIG. 1) can determine that the user is performing a comparison-type search. In another example, if the trigger word is only “Romerts,” analysis module 112 (FIG. 1) could determine that the user is performing an informational-type search. In still another example, if the trigger words include “Romerts Pygmy horse power,” analysis module 112 (FIG. 1) could determine that the user is performing a statistics-type search. In still another example, if the trigger words include “Romerts Pygmy recall,” analysis module 112 (FIG. 1) could determine that the user is performing a government notice-type search. In still other examples, if the trigger words include “How To Fix a Romerts Pygmy . . . ” or “Instructions to repair a Romerts Pygmy,” analysis module 112 (FIG. 1) could determine that the user is performing a Instructive-type search.

Subsequently, method 200 of FIG. 2 includes an activity 253 of determining an editorial mix. In some examples, activity 253 can include using at least one computer processor to determine an editorial mix based upon the search type. In some examples, analysis module 112 (FIG. 1) can determine the editorial mix. In various embodiments, the editorial mix for search-types (comparison-type searches, informational-type searches, statistics-type searches, notice-type searches, etc.) can be stored in a database of storage module 117 (FIG. 1). The editorial mix can be a parameter set by an administrator of computer system 100 (FIG. 1) or can be derived or evolve over time based upon a machine learning algorithm based on the type of results to which a user responds (e.g., the type of search results that the user clicks on a search results web page that can be customized to the user by user account, internet protocol (IP) address, device, identification, etc.).

The editorial, mix can be a list or group of two or more types of sources or references (e.g., web pages) that will be shown to the user as the search results. For example, for comparison-type searches, the editorial mix can include the manufacturer's web page(s), an “Encyclopedic” reference (i.e., a reference that expresses primarily quantitative information about the search product), two or more journalistic review of the product (e.g., references that express an opinion but based on facts and provided by an expert), and at least one favorable rant (i.e., a positive product review), and at least one unfavorable rant (i.e., a negative review of the product. These rants can be non-journalist, non-expert user reviews of the product or service.

In another example, the editorial mix for informational-type search can include trusted source(s) written at the high school reading level, trusted sources written at the 6th grade reading level, encyclopedia-type sources (e.g., an online encyclopedia or dictionary, a Wiki), and other non-trusted sources with related information. In still another example, the editorial mix for statistics-type search can include trusted source(s) that includes the statistic (e.g., source with a .gov domain, the website of a manufacturer of the producer, online academic journals), trusted new sources (e.g., Reuters new service, Associated Press new service, Arizona Republic website), other news source that includes the statistic (e.g., blogs), and sources that has a different number for the same statistic. The different numbers for the same statistic could be because the sources are possibly dated differently or reported from different source.

In these examples, a trusted source can be a source that has proven creditability. In one example, a list of trusted sources can be stored in storage module 117 (FIG. 1). In some examples, an administrator of computer system 100 (FIG. 1) can enter the list of trusted sources into computer system 100. In the same or different example, computer system 100 can determine if a source is trusted based on a number of factors (e.g., domain type (i.e., .edu, .gov, etc), links from other trusted sources, number of incoming links, context of link to source on other web pages).

Next, method 200 of FIG. 2 includes an activity 254 of determining potential or preliminary search results. In some examples, activity 254 can include using the at least one computer processor to determine potential search results based upon the one or more trigger words. In various embodiments, preliminary results module 111 (FIG. 1) can determine potential search results based upon the one or more trigger words.

In some examples, preliminary results module 111 (FIG. 1) can use the trigger words ranked by quantitative scoring. That is, preliminary results module 111 (FIG. 1) can rank the search results based upon objective or easily quantifiable properties (e.g., number of time the search term appears in the document, number of other web pages that link to the document). In many examples, preliminary results module 111 (FIG. 1) can create potential search results that include at least two potential sources (e.g., source 102 and 103 (FIG. 1)). In various examples, preliminary results module 111 (FIG. 1) can assign a preliminary score to each of the potential search results based upon its relevance to the search.

In other examples, preliminary results module 111 (FIG. 1) can use other methods to determine the preliminary search results. For example, preliminary results module 111 (FIG. 1) can use the editorial mix for a specific search to search for results that fit into the specific categories of the editorial mix.

Method 200 in FIG. 2 continues with an activity 255 of determining a classification of the potential search results. In some examples, activity 255 can include using the at least one computer processor to sort, arrange, or otherwise determine a classification of the potential search results into two or more qualitative categories based on the content of the potential sources. In some examples, classification module 113 (FIG. 1) can classify the potential search results.

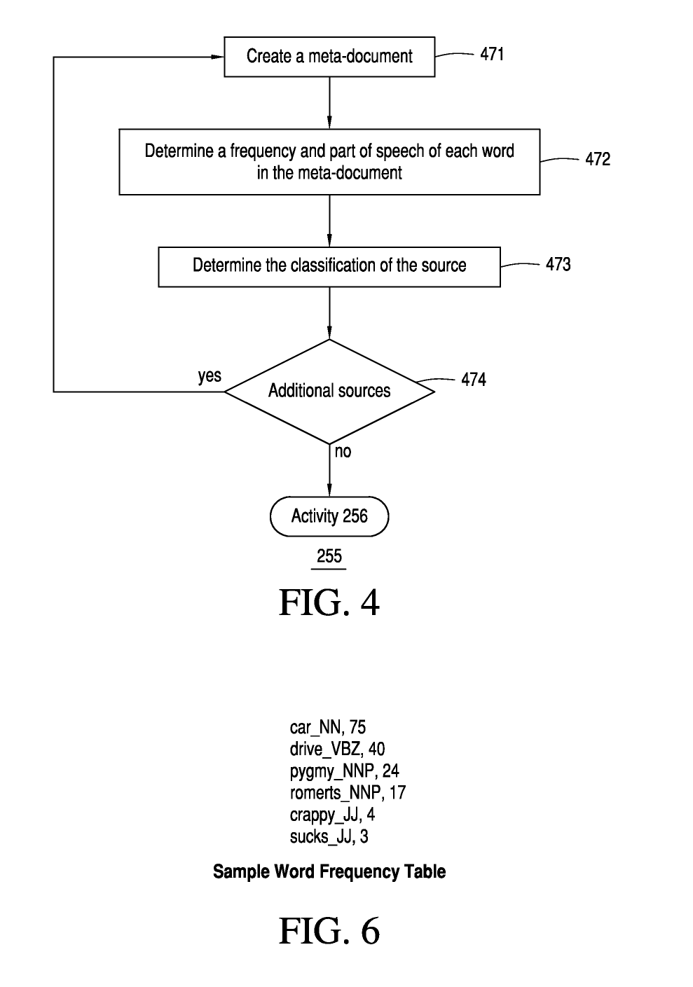

In various examples, classification module 113 (FIG. 1) can classify into two or more qualitative categories or classifications such as writing style (encyclopedic, journalistic, rant, etc.), point-of-view (for, against, neutral), bias (e.g., pro-republican, anti-republican, pro-democrat, anti-democrat, etc.), intent, sentiment, and other qualitative traits. When writing, the intent of the author typically dictates the vocabulary used. While different audiences and subjects change this approach slightly, classifying a type of source can be handled efficiently using a dictionary and comparing the word usage in a source against the dictionary. FIG. 4 illustrates a flow chart for an exemplary embodiment of activity 820 of determining a classification of the potential search results, according to the first embodiment.

Referring to FIG. 4, activity 255 includes a procedure 471 of creating a meta-document (e.g., a mark-up) for a source in the potential search results. In some examples, procedure 471 can include creating a meta-document based upon the content of a source (e.g., source 102, 103, or 104 (FIG. 1)). Most prior art context classification systems use stop words and ignore adjectives. However, for the purpose of classifying a document in terms of its writing style, intent, bias, sentiment, and other qualitative traits, it is useful to identify how adjectives are used.

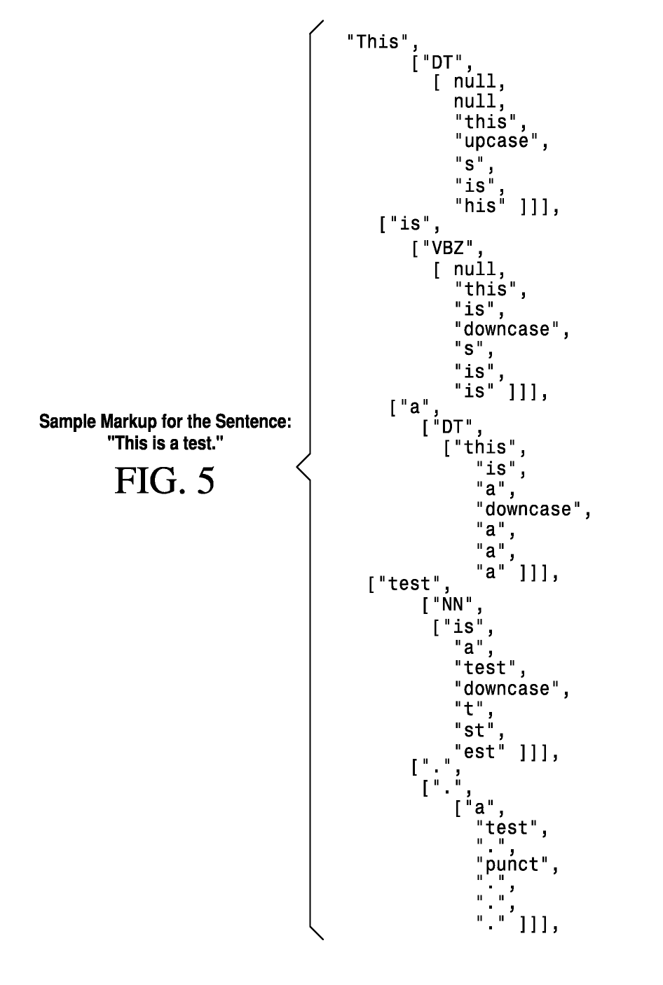

Identifying and classifying adjectives can be typically very computationally intense. To reduce the computation requirements, classification module 113 (FIG. 1) can reduce sources to meta-documents. In many examples, classification module 113 (FIG. 1) can use a natural language analyzer to automatically generate the meta-document in real time. FIG. 5 illustrates an example of a sample mark-up for the sentence “This is a test” using a natural language analyzer. In this example, a Penn Tree method is applied to create the mark-up, but any sufficiently advanced natural language markup can be used instead. In the example mark-up shown in FIG. 5, the mark-up is arranged for each word or punctuation in the sentence as follows: the word, parts-of-speech (e.g., using the Penn parts-of-speech tags where “DT” stands for Determiner, “VBZ” stands for third person singular present verb, “NN” stands for a singular or mass noun), previous word, previous word, lowercase version of word (for efficient matching), original case (e.g., uppercase or downcase), last letter/suffix, last two letter suffix, and last three letter suffix.

Classification module 113 (FIG. 1) can apply a natural language mark-up method (e.g., the Penn Tree method) to create a mark-up for the complete source (i.e., the whole document). In other examples, classification module 113 (FIG. 1) can use other methods or procedures to mark-up and/or create a meta-document for the source.

In some examples, as part of creating the mark-up for the source, classification module 113 can be configured to not include quotations from the source in the meta-document. When determining if a source has a positive or negative sentiment about a subject, separation of quotes from the author's sentiment can be useful to ensure accurate results. In some examples, classification module 113 (FIG. 1) can using natural language processing to first identify the portions of text that are quotes, and then removing them from the classification results to help to differentiate the speaker's sentiment from the author's sentiment.

For example, a source might say “According to a speech given by imaginary politician Bob Falseteller, ‘The Elbonian government is entirely made up of thieves and commies.’ This lead to outrage by the Elbonian people.” The sentiment of the author of this source is neutral. The sentiment of Bob Falseteller, who is quoted in the source, is highly negative towards the Elbionian government. When classifying this content (in procedure 473 below), the source could be classified as “encyclopedic” or “journalistic,” despite the quote which is more rant-like in nature. If the quoted text were included in the mark-up, this source could possibly be misclassified as a “rant.”

In the same or different examples, classification module 113 (FIG. 1) can separate and store the quotations. Rarely in the context of searching for “encyclopedic” or “journalistic” sources does the author care what a journalist said. Instead, it is usually more interested in what the person, who the journalist is reporting about, said. Separating the writings of the author and the quotes from the quoted person allows for the ability to find relevant information from an authoritative source.

In some examples, classification module 113 (FIG. 1) can using natural language processing to first identify the portions of text that are quotes, indexing them, and storing the quotes differentially (e.g., separately) from the body of the content in storage device 117 (FIG. 1). This differentiation and storage allows for quote only searching, or searching of quotes by specific individuals.

Activity 255 in FIG. 4 continues with a procedure 472 of determining a frequency and parts-of-speech of each word in the meta-document. In some examples, classification module 113 (FIG. 1) can analyze the meta-document to determine the frequency of each word in the source and the parts-of-speech of each word in the source.

FIG. 6 illustrates an example of a word frequency table of a sample source, according to an embodiment. In the example shown in FIG. 6, the words are sorted by word and parts-of-speech (e.g., using the Penn parts-of-speech tags where “NNP” stands for singular proper noun, “VBZ” stands for third person singular present verb, “NN” stands for a singular or mass noun, and “JJ” stands for an adjective.)

Referring back to FIG. 4, activity 255 of FIG. 4 continues with a procedure 473 of determining the classification of the source. In some examples, procedure 473 can include determining the classification of the source using the frequency and the parts-of-speech of each word in the meta-document.

In various examples, classification module 113 (FIG. 1) can use various predetermined rubrics to determine how to classify a document based upon the words and the parts-of-speech of each word. For example, classification module 113 (FIG. 1) can identify the source of the word frequency table in FIG. 6 as a rant (e.g., a non-journalist, non-expert opinion writing). Classification module 113 (FIG. 1) also can identify this source as a rant based upon the multiple uses of the adjectives “crappy” and “sucks.” That is, classification module 113 (FIG. 1) can apply a predetermined weight to each of those words for determining if this source meets the definition of a rant, without having to parse the entire source. On the other hand, classification module 113 (FIG. 1) could look at the nouns and verbs in the source to determine this source is about computers and computation.

By storing parts-of-speech and frequency along with the keyword data, not only is efficiency greatly increased, but accuracy is increased as well. For example, the sentence “I don't want to truck this gravel to Nevada.” uses “truck” as a verb, not the more common usage as a noun. This usage greatly changes the way classification module 113 (FIG. 1) determines if this source is a piece of content about vehicles, or about shipping, as a vehicle classifier might give the noun truck a larger score than the verb truck if the parts-of-speech were unknown.

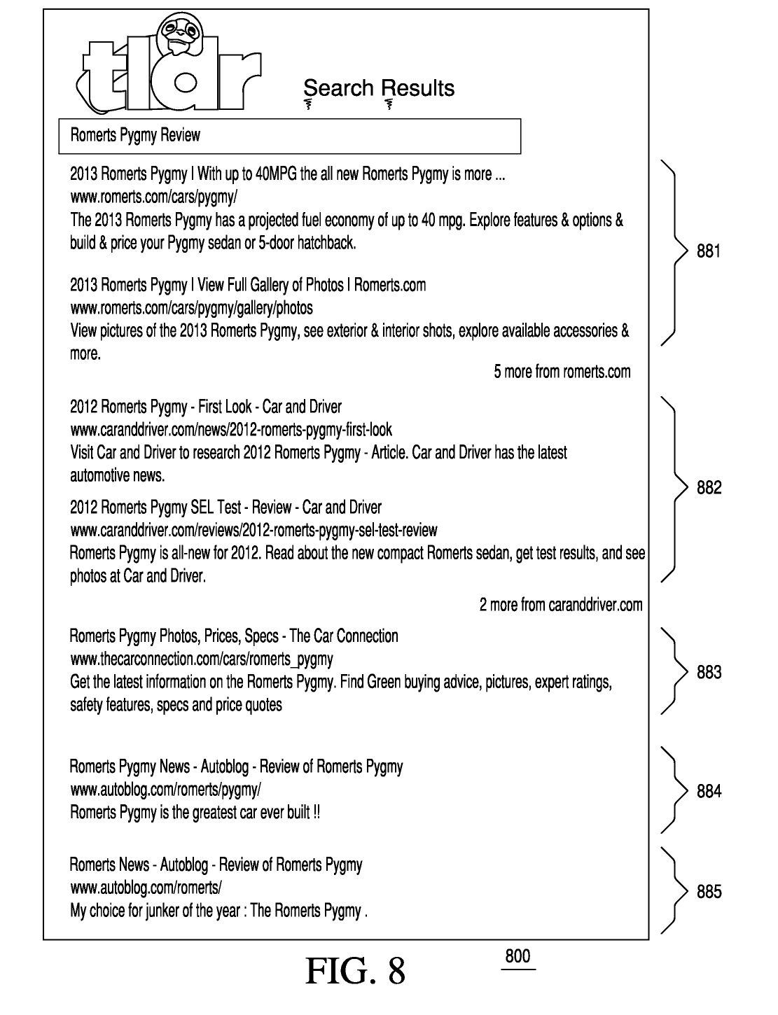

Next, activity 255 of FIG. 8 includes a procedure 474 of determining whether any additional sources need to be classified. If additional sources need classification, the next procedure in activity 255 is procedure 471. If no additional sources need classification, activity 255 is complete, and the next activity is an activity 256 (FIG. 2).

Referring again to FIG. 2, method 200 of FIG. 2 includes an activity 256 of determining a score for the potential sources results. In some examples, activity 256 can include using a computer processor to determine a score for the potential search results at least partially based upon the editorial mix of the potential search results. In some examples, scoring module 115 (FIG. 1) can assign the score to the potential search results based upon the editorial mix and the classification of the potential search results.

For example, scoring module 115 (FIG. 1) can sort the potential search results by type and then apply bonus points to each of the sources in the potential search results based on the editorial mix for the search. In the example of a search for “Romerts Pygmy Review” where the search type was a comparison-type search, the bonus points could be manufacturer: +1000 point, encyclopedic: +500 points, journalistic review: +400 points, positive rant: +300 points, and negative rant: +300 points.

In another example, scoring module 115 (FIG. 1) can apply bonus points to a source if that source links a relevant asset based on the search type. For searches which are detected as document searches (e.g., search for PDF (portable document format) or non-HTML (hypertext markup language) files) or that are detected that the best answer is likely contained in a PDF or other non-HTML document or file. A bonus is awarded to the source that links to the non-HTML document or file. Scoring module 115 (FIG. 1) can also apply bonus point to a source when where the ideal result is a non-text item that does not “display” in a browser (e.g., executable files or archive/compressed files). That is, executable files (e.g., .exe files) and archive/compressed files (e.g., Zip and DMG) cannot be rendered in a browser, but are often what the user is search for (e.g., search for “download XYZ application”). Awarding bonuses (e.g., +200 points) to the source(s) that links to the non-displayable ideal result provides a safer, more user friendly way to present access to the relevant result.

Next, method 200 of FIG. 2 includes an activity 257 of determining the search results. In some examples, activity 257 can include using the at least one computer processor to create the search results at least partially based upon the potential search results, the editorial mix, and the score for the potential sources results. In some examples, mix module 114 (FIG. 1) can create the list of top results based upon the scores for the potential search results.

In some cases a “slot” would be reserved for a specific type of result. A car manufacture or “brand” would likely always occupy the top place for a search for that brand, regardless of the authority, popularity, or number of links for that source. A search for something with the word “sucks” might create two slots for negative results and a slot for a positive review, even if the positive review does not include the word “sucks.”

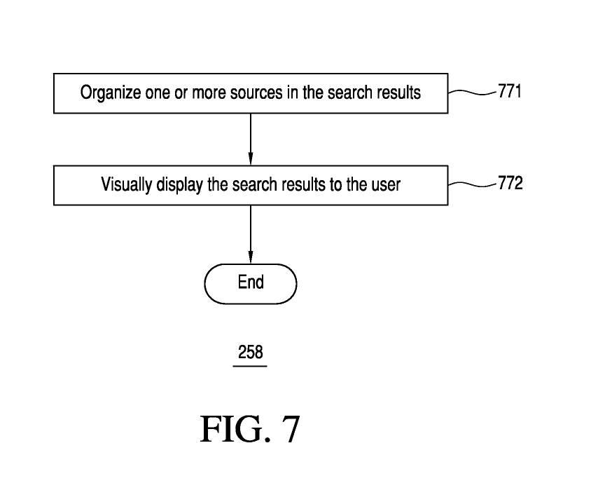

Method 200 in FIG. 2 continues with an activity 258 of communicating the search results to the user. FIG. 7 illustrates a flow chart for an exemplary embodiment of activity 258 of communicating the search results to the user, according to the first embodiment.

Referring to FIG. 7, activity 258 includes a procedure 771 of organizing one or more sources in the search results. In some examples, procedure 771 can include organizing one or more elements of the search results based upon the classification of the potential search results. In many examples, organization module 121 (FIG. 1) can organize the results based upon the editorial mix for the specific search and the score for the potential search results. The search results can include sources within at least two different classifications.

In various embodiments, organization module 121 (FIG. 1) can include the predetermined mix of source types by picking the highest scoring references of each type to fill the available positions in the search results. Additional slots of the search results pages can be filled in by the highest scoring reference, not already included in the search results.

FIG. 8 illustrates an exemplary search results web page 800 for the “Romerts Pygmy Review” search, according to an embodiment. In this example, organization module 121 (FIG. 1) has included two sources 881 from the manufacturer as the top results (one with information about the vehicle and the other with pictures of the vehicle), two journalistic review sources 882, an encyclopedic source 883, a positive rant source 884, and a negative rant source 885.

Activity 258 in FIG. 7 continues with a procedure 772 of displaying the search results to the user. In some examples, procedure 772 can include visually displaying the search results to the user on a web page (e.g., web page 800 of FIG. 8). In some examples, display module 122 (FIG. 1) can communicate the search results in a predetermined format (e.g., a web page) to user 106, 107, or 108 (FIG. 1) via communications network 105. In many examples, the search results can be visually displayed by display module 122 (FIG. 1) using a display on a computing device of user 106, 107, or 108. After procedure 772, activity 258 and method 200 (FIG. 2) are complete.

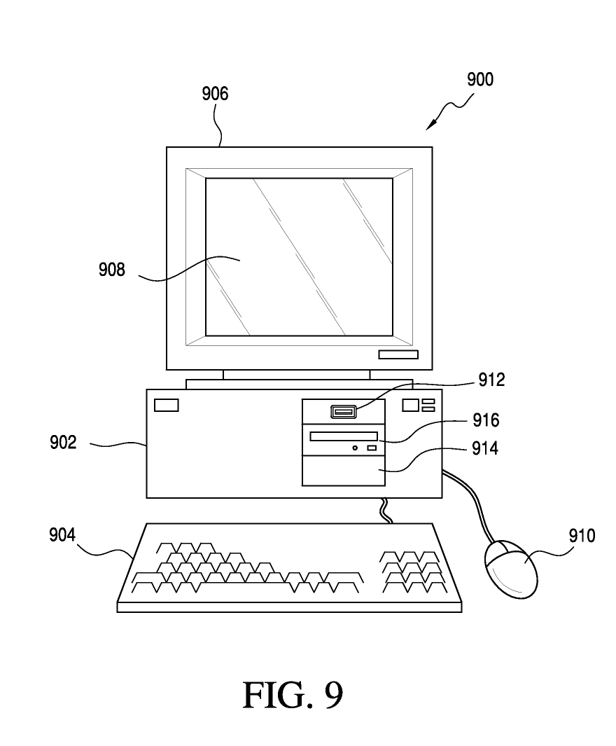

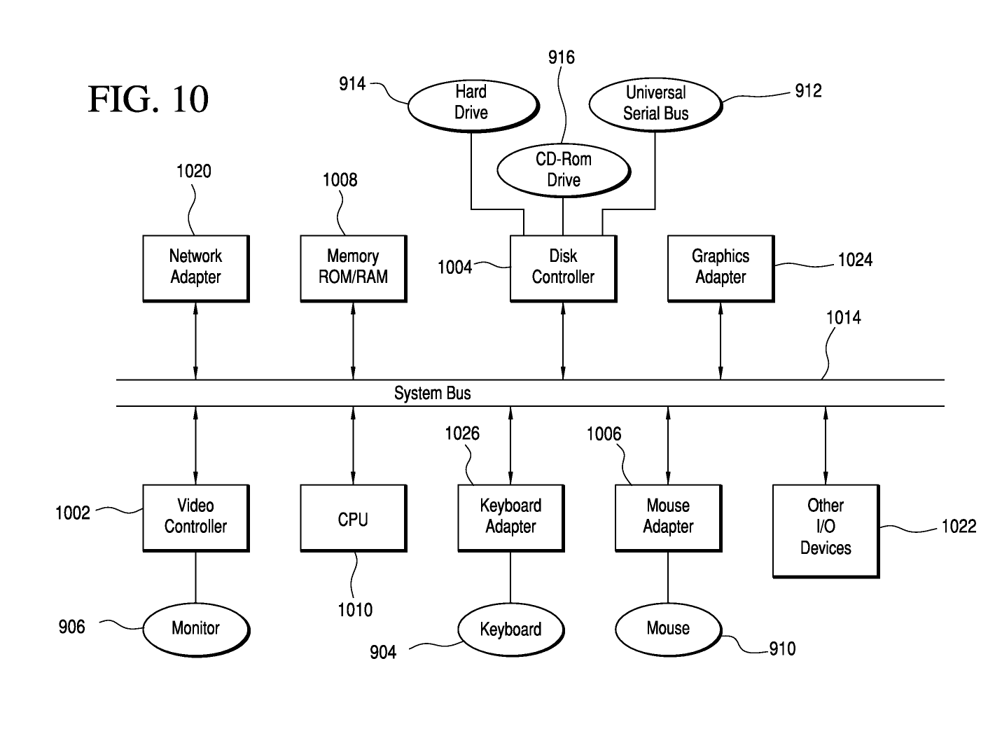

FIG. 9 illustrates a computer 900 that is suitable for implementing an embodiment of at least a portion of computer system 100 (FIG. 1). Computer 900 includes a chassis 902 containing one or more circuit boards (not shown), a USB (universal serial bus) port 912, a Compact Disc Read-Only Memory (CD-ROM) and/or Digital Video Disc (DVD) drive 916, and a hard drive 914. A representative block diagram of the elements included on the circuit boards inside chassis 902 is shown in FIG. 10. A central processing unit (CPU) 1010 in FIG. 10 is coupled to a system bus 1014 in FIG. 10. In various embodiments, the architecture of CPU 1010 can be compliant with any of a variety of commercially distributed architecture families.

System bus 1014 also is coupled to non-volatile memory 1008 that includes both read only memory (ROM) and random access memory (RAM). Non-volatile portions of memory 1008 or the ROM can be encoded with a boot code sequence suitable for restoring computer 900 (FIG. 9) to a functional state after a system reset. In addition, memory 1008 can include microcode such as a Basic Input-Output System (BIOS). In some examples, storage module 117 (FIG. 1) can include a USB drive in USB port 912, on a CD-ROM or DVD in CD-ROM and/or DVD drive 916, hard drive 914, or non-volatile memory 1008

In the depicted embodiment of FIG. 10, various I/O devices such as a disk controller 1004, a graphics adapter 1024, a video controller 1002, a keyboard adapter 1026, a mouse adapter 1006, a network adapter 1020, and other I/O devices 1022 can be coupled to system bus 1014. Keyboard adapter 1026 and mouse adapter 1006 are coupled to a keyboard 904 (FIGS. 9 and 10) and a mouse 910 (FIGS. 9 and 10), respectively, of computer 900 (FIG. 9). While graphics adapter 1024 and video controller 1002 are indicated as distinct units in FIG. 10, video controller 1002 can be integrated into graphics adapter 1024, or vice versa in other embodiments. Video controller 1002 is suitable for refreshing a monitor 906 (FIGS. 9 and 10) to display images on a screen 908 (FIG. 9) of computer 900 (FIG. 9). Disk controller 1004 can control hard drive 914 (FIGS. 9 and 10), USB port 912 (FIGS. 9 and 10), and CD-ROM or DVD drive 916 (FIGS. 9 and 10). In other embodiments, distinct units can be used to control each of these devices separately.

Network adapters 1020 can be coupled to one or more antennas. In some embodiments, network adapter 1020 is part of a WNIC (wireless network interface controller) card (not shown) plugged or coupled to an expansion port (not shown) in computer 900. In other embodiments, the WNIC card can be a wireless network card built into internal computer 900. A wireless network adapter can be built into internal client computer 900 by having wireless Ethernet capabilities integrated into the motherboard chipset (not shown), or implemented via a dedicated wireless Ethernet chip (not shown), connected through the PCI (peripheral component interconnector) or a PCI express bus. In other embodiments, network adapter 1020 can be a wired network adapter.

Although many other components of computer 900 (FIG. 9) are not shown, such components and their interconnection are well known to those of ordinary skill in the art. Accordingly, further details concerning the construction and composition of computer 900 and the circuit boards inside chassis 902 (FIG. 9) need not be discussed herein.

When computer 900 in FIG. 9 is running, program instructions a USB drive in USB port 912, on a CD-ROM or DVD in CD-ROM and/or DVD drive 916, on hard drive 914, or in non-volatile memory 1008 (FIG. 10) are executed by CPU 1010 (FIG. 10). A portion of the program instructions, stored on these devices, can be suitable for carrying out method 200 (FIG. 2) as described previously with respect to FIGS. 1-8.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that activities 251-258 of FIG. 2, procedures 471-474 of FIG. 4, and procedures 741-742 of FIG. 7 may be comprised of many different activities, procedures and be performed by many different modules, in many different orders that any element of FIG. 1 may be modified and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method for organizing two or more search results, the method comprising:
receiving at least one search parameter from a user;
using at least one computer processor to determine a search type based upon the at least one search parameter;
using the at least one computer processor to determine potential search results based upon the at least one search parameter;
using the at least one computer processor to determine one or more qualitative traits of the potential search results;
using the at least one computer processor to organize the two or more search results based upon the search type and the one or more qualitative traits of the potential search results; and
displaying the two or more search results to the user.

2. The method of claim 1, wherein:
the one or more qualitative traits of the potential search results comprises one or more of: a writing style of the potential search results, a point-of-view of the potential search results, a bias of the potential search results, or a sentiment of the potential search results.

3. The method of claim 1, further comprising:
using the at least one computer processor to determine a results mix based upon the search type,
wherein:
using the at least one computer processor to organize the two or more search results comprises:
determining the two or more potential search results in the potential search results to be included in the two or more search results based upon the results mix and the one or more qualitative traits of the potential search results.

4. The method of claim 1, wherein:
using the at least one computer processor to determine the one or more qualitative traits of the potential search results comprises:
determining parts-of-speech and a frequency of words in each result of the potential search results; and
using parts-of-speech and the frequency of the words in each result of the potential search results to determine the one or more qualitative traits of the potential search results.

5. The method of claim 4, wherein:
using the at least one computer processor to determine the one or more qualitative traits of the potential search results further comprises:
removing quoted text from each result of the potential search results before determining the parts-of-speech and the frequency of the words.

6. A system configured to generate search results from three or more sources based upon one or more trigger words received from a user, the system generates the search results using at least one computer processor, the system comprising:
a communications module configured to be executed using the at least one computer processor and further configured to receive the one or more trigger words from the user and to communicate the search results to the user;
a preliminary results module configured to be executed using the at least one computer processor and further configured to determine potential search results based upon the one or more trigger words, the potential search results comprises at least two potential sources from the three or more sources;
an analysis module to determine a search type based upon the one or more trigger words;
a classification module configured to classify the potential search results into two or more predetermined qualitative categories based on a content of the at least two potential sources;
a mix module configured to determine an editorial mix of the search results based upon the search type and the potential search results, the editorial mix comprises two or more types of sources;
a scoring module configured to determine a score for each source in the potential search results at least partially based upon the editorial mix of the search results; and
a results determining module configured to create the search results at least partially based upon the potential search results, the editorial mix of the search results, and the score for each source in the potential search results.

7. The system of claim 6, wherein:
the classification module is further configured to determine a writing style classification of each of the at least two potential sources; and
the two or more predetermined qualitative categories comprise the writing style classification.

8. The system of claim 6, wherein:
the classification module is further configured to determine a point-of-view classification of each of the at least two potential sources; and
the two or more predetermined qualitative categories comprise the point-of-view classification.

9. The system of claim 6, wherein:
the classification module is further configured to determine a classification into the predetermined qualitative categories by: (a) creating one or more meta-documents based upon the content of the at least two potential sources; (b) determine a frequency and parts-of-speech of each word in the meta-document; and (c) determine the classification of the at least two potential sources using the frequency and the parts-of-speech of the content of the meta-document.

10. The system of claim 6, wherein:
the scoring module is further configured to assign the scores to the at least two potential sources based upon the editorial mix and the classification of the at least two potential sources.

11. The system of claim 6, wherein:
the communications module comprises:
an organization module configured to organize the search results based upon one or more classifications of the at least two potential sources into the predetermined qualitative categories.

12. The system of claim 11, wherein:
the organization module is further configured to determine first information to display to the user about a first source of the at least two potential sources wherein the first one of the at least two potential sources has a first classification of the one or more classifications;
the organization module is further configured to determine second information to about two or more second sources of the at least two potential sources wherein the two or more second sources of the at least two potential sources have a second classification of the one or more classifications; and
the editorial mix comprises at least one reference with the first classification and at least two references with the second classification.

13. The system of claim 12, wherein:
the communications module further comprises:
a display module configured to visually display the first information and the second information to the user on a web page.

14. A method for displaying information to a user based upon one or more trigger words, the method comprising:
receiving the one or more trigger words from the user;
using at least one computer processor to determine a search type based upon the one or more trigger words;
using the at least one computer processor to determine an editorial mix based upon the search type, the editorial mix comprises two or more types of sources;
using the at least one computer processor to determine a potential search results based upon the one or more trigger words, the potential search results comprise at least two potential sources;
using the at least one computer processor to determine one or more classifications of the potential search results into two or more qualitative categories based on a content of the potential search results;
using the at least one computer processor to determine scores for the at least two potential sources at least partially based upon the editorial mix;
using the at least one computer processor to determine search results at least partially based upon the potential search results, the editorial mix, and the scores for the at least two potential sources; and
communicating the search results to the user.

15. The method of claim 14, wherein:
using the at least one computer processor to determine the scores comprises:
using the at least one computer processor to assign the scores to the at least two potential sources at least partially based upon the editorial mix and the one or more classifications the potential search results.

16. The method of claim 14, wherein:
communicating the search results comprises:
organizing the search results based upon the one or more classifications the potential search results.

17. The method of claim 14, wherein:
communicating the search results comprises:
visually displaying the search results to the user on a web page.

18. The method of claim 17, wherein:
visually displaying the search results to the user on the web page comprises:
displaying information about a first source of the at least two potential sources wherein the first source of the at least two potential sources has a first classification of the one or more classifications;
displaying information about two or more second sources of the at least two potential sources wherein the two or more second sources of the at least two potential sources have a second classification of the one or more classifications; and
the editorial mix comprises at least one reference with the first classification and at least two references with the second classification.

19. The method of claim 14, wherein:
using the at least one computer processor to determine the one or more classifications comprises:
using the at least one computer processor to determine a writing style classification of each of the at least two potential sources; and
the two or more qualitative categories comprise the writing style classification.

20. The method of claim 14, wherein:
using the at least one computer processor to determine the one or more classifications comprises:
using the at least one computer processor to determine a point-of-view classification of each of the at least two potential sources; and
the two or more predetermine qualitative categories comprise the point-of-view classification.

21. The method of claim 14, wherein:
using the at least one computer processor to determine the one or more classifications comprises:
creating at least one meta-document based upon the content of the two or more potential search results;
determining a frequency and parts-of-speech of words in the at least one meta-document and;
determining a classification of a first source of the two or more potential search results using the frequency and the parts-of-speech of the words in the at least one meta-document.
